(19) United States
(12) Patent Application Publication
(10) Pub. No.: US 2009/0325533 A1
(43) Pub. Date: Dec. 31, 2009

(54) METHOD FOR USING AN ADAPTIVE WAITING TIME THRESHOLD ESTIMATION FOR POWER SAVING IN SLEEP MODE OF AN ELECTRONIC DEVICE

(76) Inventors: Abhijit Lele, Bangalore (IN); Ramakrishnan R, Bangalore (IN); Debabrata Das, Bangalore (IN); Piyush Kumar Jain, Chhattishgarh (IN); Khyati Sanghvi, Gujrat (IN)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/147,608

(22) Filed: Jun. 27, 2008

(51) Int. Cl. H04B 1/16

(52) U.S. Cl. 455/343.1

(57) ABSTRACT

Portable battery operated electronic devices often use a “sleep mode” for energy conservation. A key feature introduced in the IEEE 802 standard ensures power-efficient operation of these battery operated mobile devices. However, the standard fails to define what will trigger a device into the sleep mode while other systems define “waiting time threshold” as a time for which a Mobile Subscriber Station (MSS) waits before entering into sleep mode which has a constant duration. An embodiment of the present invention uses a unique method (1500) and algorithm for optimizing waiting time threshold (1509) according to traffic arrival pattern for uplink (UL) and downlink (DL) data packets. This leads to significant reduction in energy consumption with little increase in average waiting delay and acceptable end-to-end delay for non real time traffic.

### FIELD OF THE INVENTION

The present invention is directed to power conservation in portable electronic devices and more particularly to the use of adaptive waiting time threshold estimation for activation of a sleep mode in an electronic device.

### BACKGROUND

The extensive growth of the Internet over the last decade has lead to an increasing demand for ubiquitous, high speed Internet access. Broadband Wireless Access (BWA) is increasingly gaining popularity as alternative “last-mile” technology to xDSL lines and cable modems. Worldwide Interoperability for Microwave Access (WiMAX), which is based on the Institute of Electrical and Electronic Engineers (IEEE) 802.16 standard, is the most promising technology that enables convergence of fixed and mobile broadband networks. While IEEE 802.16 is designed to provide fixed wireless access with high bandwidth, its related extension IEEE 802.16(e) is aimed to support mobility.

Portable mobile devices are characterized by both their limited computing capacity and energy availability. Of late, researchers have focused on maximizing the battery life of mobile stations by efficient energy management techniques. Display, hard disk, logic, and memory are the device components with the greatest impact on power consumption; however, when a wireless interface is added to a portable system, power consumption increases significantly. Assuming that the wireless interface on the mobile device is an 802.16(e) compliant interface, most of the power consumption in an 802.16(e) wireless interface is consumed by the trans-receiver. Hence, power saving can be achieved by optimizing trans-receiver power consumption.

The IEEE 802.16(e) standard defines a sleep mode operation, which can be exploited as a potential power saving mechanism. Sleep mode is a state in which the mobile subscriber station (MSS) conducts pre-negotiated periods of absence from the Base Station (BS) air interface. These periods are characterized by the unavailability of the MSS, as observed from the BS, to downlink (DL) or uplink (UL) traffic. Additionally, the 802.16(e) defines three power saving classes, namely, power saving Classes A, B, and C. Power saving Class A is recommended for Best Effort (BE) and Non Real Time-Variable Rate (NRT-VR) connections. Power saving Class B is recommended for Unsolicited Grant Service (UGS) and Real Time-Variable Rate (RT-VR) connections. Power saving Class C is for multicast and management connections. Each connection is classified in one of the power saving classes on the basis of demand properties. However, the standard does not define an algorithm for choosing a power saving class type for certain connections.

In power saving Class A, the sleep mode is initiated after negotiation between MSS and BS on operational parameters such as minimum sleep window (Tₘᵢₙ), maximum sleep window (Tₘₐₓ), listening period (L), and starting frame number for sleep window (F). Initially, MSS goes to sleep mode for Tₘᵢₙ duration. Sleep windows are interleaved with listening windows of fixed duration in which the MSS checks for any pending downlink packets at BS and in the presence of pending packets the MSS transits to active mode. In absence of traffic, the MSS continues to be in sleep mode with exponential increase in sleep window size till sleep window reaches to Tₘₐₓ. During the sleep mode, if the MSS has any uplink packet to transmit, it immediately will transition to active mode. The MSS enters the sleep mode from the active mode when there is no traffic destined to itself for the time interval called waiting time threshold. Waiting time threshold is an important operational parameter in performance of sleep mode.

The prior art includes some research that has been performed directed to the efficient management of energy through sleep mode. Performance analysis of sleep mode has been carried out by developing both an analytical model and Phase-type-based Markov chain models. There has been research done on the analysis of operation parameters for energy consumption optimization using queuing behavior and inter arrival time. But limited research has been reported on waiting time threshold where the effect of waiting time threshold on performance before device enters to sleep mode is discussed. The research which has been done in this area has quite a few limitations. Little of this research has considered constant threshold relating only to downlink traffic. Moreover, in the prior art, the MSS is considered in idle mode during threshold duration, and power consumption values for threshold duration are calculated like that of listening duration. This indicates some of the operations of the MSS are switched off during threshold duration, which may lead to the loss of important information.

As the IEEE 802.16(e) standard does not specify how to determine when the MSS should switch to sleep mode, two scenarios can be considered. First, the MSS will send a sleep request and try to go to sleep mode immediately after receiving a DL packet. This is provided that there is no UL packet to transmit, i.e., an absence of a waiting time threshold. These frequent sleep request messages will increase overhead on the network. In the second scenario, the MSS will wait for a constant time before sending a sleep request, i.e., constant waiting time threshold. In this scenario, the MSS might wait for a longer duration before switching to sleep mode at a low traffic volume, leading to less sleep duration. Moreover, in both the scenarios, the MSS might experience frequent sleep-active transitions due to unawareness of packet arrival. Thus, both of the scenarios result in more energy consumption of battery power.

In that no research has been reported on power saving through the use of an adaptive waiting time threshold that takes into consideration a stochastic traffic arrival pattern in DL and UL communications, an aspect of the present invention is direct to such a scenario.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is timing diagram illustrating a typical relationship among the different time intervals when an MSS is served by the BS.

FIG. 2 illustrates a DL or UL packet arrival at an MSS during waiting time threshold duration.

FIG. 3 illustrates a timing diagram showing sleep mode interruption due to the presence of a UL MAP with no DL MAP arrival at the BS for the MSS.

FIG. 4 illustrates a DL MAP arriving at the BS for the MSS with no UL MAP present at the MSS.

FIG. 5 illustrates a timing diagram showing the MSS in a sleep mode that is interrupted by arrival of a UL map with at least one DL MAP present at the BS for the MSS during the nth sleep interval.

FIG. 6 is a graph illustrating a comparison of average energy consumption (mW) by the MSS versus the mean arrival rate (λ) at R=4 for analytical and simulation results.

FIG. 7 is a graph illustrating a comparison of average energy consumption (mW) by the MSS versus the mean arrival rate (λ) at R=4 the standard algorithm and the algorithm proposed by an embodiment of the present invention.

FIG. 8 is a graph illustrating a comparison of average threshold duration versus mean arrival rate (λ) at R=4 for the standard algorithm and the algorithm proposed by an embodiment of the present invention.

FIG. 9 is a graph illustrating a comparison between average sleep duration versus mean arrival rate (λ) at R=4 for the standard algorithm and the algorithm proposed by an embodiment of the present invention.

FIG. 10 is a graph illustrating a comparison between average delay in transmission of DL and UL frames due to the MSS in sleep mode versus mean arrival rate (λ) at R=4 for the standard algorithm and the algorithm proposed by an embodiment of the present invention.

FIG. 11 is a graph illustrating a comparison between average energy consumption versus mean arrival rate (λ) at R=4 for the standard algorithm and the algorithm proposed by an embodiment of the present invention.

FIG. 12 is a graph illustrating a comparison between average threshold duration versus mean arrival rate (λ) at R=4 for the standard algorithm and the algorithm proposed by an embodiment of the present invention.

FIG. 13 is a graph illustrating a comparison between average sleep duration versus mean arrival rate (λ) at R=4 for the standard algorithm and the algorithm proposed by an embodiment of the present invention.

FIG. 14 is a graph illustrating a comparison between the average delay in transmission of DL and UL frames due to the MSS in sleep mode versus mean arrival rate (λ) at R=4 for the standard algorithm and the algorithm proposed by an embodiment of the present invention.

FIG. 15 is a flowchart diagram illustrating the use of a method using the algorithm of the present invention in an electronic device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a complementary cumulative distribution driven level convergence system and method. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

According to an embodiment of the present invention, an algorithm as defined herein operates to dynamically adjust the waiting time threshold based on arrival rate of down link (DL) and up link (UL) frames in order to minimize power consumption. For an initial waiting time threshold (Tₜₕ), Tₜₕ=Tₜₕ_{_{—}}ₘᵢₙ, where Tₜₕ_{_{—}}ₘᵢₙ is the minimum limit of the waiting time threshold. For subsequent calculations:

$${T}_{th} = \begin{matrix}{T}_{th} \\ {T}_{th\_max}\end{matrix} \{ \begin{matrix}if {T}_{th} < {T}_{th\_max} \\ Otherwise\end{matrix} \qquad ( 1 )$$

Where Tₜₕ is waiting time threshold and Tₜₕ_{_{—}}ₘₐₓ is maximum limit of waiting time threshold. On arrival of each DL or UL frame, Tₜₕ is derived as using the equations:

λₙ=(1−α)*λ_{new}+α*λₙ₋₁, 0<α<1 (2)

Tₜₕ=Tₜₕ+β*(λₙ−λₙ₋₁), β>0 (3)

Where α is a proportionality constant and β is a constant with unit sec⁻¹. λ_{new} is new arrival rate, λₙ is weighted arrival rate after n^{th} packet arrival, λₙ₋₁ is weighted arrival rate after (n−1)^{th} packet arrival, and Tₜₕ is new waiting time threshold after n^{th} packet arrival.

The algorithm operates to adapt Tₜₕ based on a DL as well as a UL traffic pattern to predict optimum duration of next waiting time threshold. Thus, waiting time threshold will be small in the case of low traffic, such that the MSS will switch to sleep mode without substantial delay, leading to increase in sleep duration. In cases of high traffic, due to large waiting time threshold, the MSS will be in active mode, leading to reduction in sleep-active transitions. So, in both of these scenarios, energy consumption will be reduced

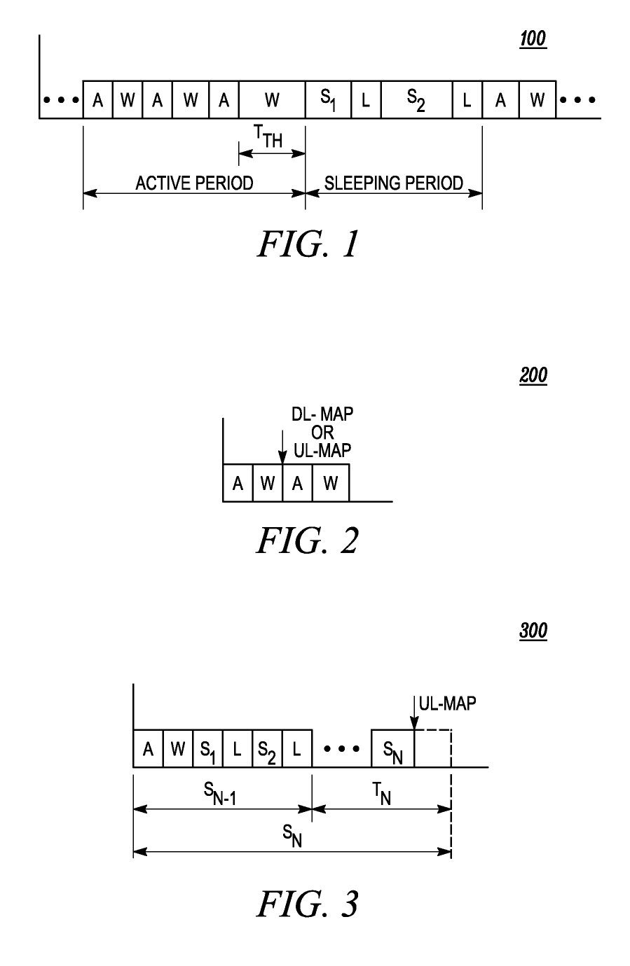

FIG. 1 illustrates a typical relationship among the different time intervals when an MSS is served by the BS. The timing diagram illustrates packets A and W that denote serving and waiting time duration; Sᵢ, L, and Tₜₕ represent the i^{th} sleep window, the listening window, and the waiting time threshold respectively. As shown in the diagram, the MSS starts waiting for time duration Tₜₕ after every DL or UL packet arrival. If any packet arrives during the waiting time threshold duration, then the MSS remains in an active mode. In a case of an absence of any packet arrival for waiting time threshold duration, then the MSS will switch to a sleep mode. The packet 100 includes an active period A, waiting time threshold W, sleep period S, and listening period L.

With regard to the analytical model, the incoming frame arrival rate and outgoing frame arrival to the MSS, follow a Poisson distribution with a rate λ_{d} and λᵤ respectively. If λ=λ_{d}+λᵤ is the total arrival rate at the MSS and the listening period is small, it will be considered as a part of sleeping period. The order of arrival of the DL and UL packets during both the waiting time threshold duration and sleeping duration can be categorized into four cases (which will be discussed herein in detail). In this analysis, the average inter arrival time is calculated on the basis of average inter arrival time we calculate the value of a new waiting time threshold. Using a calculated waiting time threshold, the energy consumption and average delay can be determined for all the four cases. The following notations have been used for the analytical model as described herein:
λ=mean arrival rate
λ_{d}=mean downlink arrival rate
λᵤ=mean uplink arrival rate
T_{th mean}=mean waiting time threshold
Tₛ=total sleep duration
Tᵢₙₜ_{_{—}}ₘₑₐₙ=mean inter arrival time
tₜ=arrival time of UL or DL frame
Eᵢ=energy consumption for case i where i={1, 2, 3, 4}
Sᵢ=total sleep and listening interval till the i^{th} sleep cycle
tₙ=sleep interval during n^{th} sleep cycle
Dᵢ=average delay in transmission of DL frame at BS for MSS due to MSS being in sleep mode for case i where i={1, 2, 3, 4}
Eₜₕ=energy consumption at the MSS during waiting time threshold
Eₛ=energy consumption at the MSS during sleep mode
E=total energy consumption at the MSS
D=total average delay at the MSS

FIG. 2 illustrates a DL or UL packet arrival at an MSS during waiting time threshold duration where the down arrow (↓) denotes the DL MAP or UL MAP between the waiting time and arrival time in the packet such that:

Tₜₕ_{_{—}}ₘₑₐₙ=4.717*(λ³)−12.49*(λ²)+21.13*(λ)+1.152 (4)

The probability that the DL or UL MAP arrives at the MSS during waiting time threshold duration, where tₙ<tₜ<tₙ+Tₜₕ_{_{—}}ₘₑₐₙ is given by:

$${P}_{1} = P ( 0 < {t}_{t} < {T}_{th\_mean} ) \\ {P}_{1} = {\int }_{0}^{{T}_{th - mean}} λ \cdot {e}^{- λ \cdot t} d t \\ {P}_{1} = 1 - {e}^{- λ \cdot {T}_{th - mean}} \qquad ( 5 )$$

So average energy consumption at the MSS during waiting time threshold duration:

E₁=Tₜₕ_{_{—}}ₘₑₐₙ*Eₜₕ (6)

and average delay contributed due to waiting time threshold duration:

D₁=0 (7)

FIG. 3 illustrates a timing diagram showing a sleep mode interruption due to presence of a UL MAP with no DL MAP arrival at the BS for the MSS. In Case II, when the UL MAP (↓) is present at the MSS for transmission during n^{th} sleep interval, while there is no DL frame arrival at BS for the MSS:

Tₜₕ_{_{—}}ₘₑₐₙ=4.717*(λ³)−12.49*(λ²)+21.13*(λ)+1.152 (8)

The average time at which a UL frame will be present at the MSS for transmission is given by determining the Tᵢₙₜ_{_{—}}ₘₑₐₙ and is given as

$$\begin{matrix}{T}_{int\_mean} = \frac{{\int }_{{S}_{n - 1}}^{{S}_{n - 1} + {t}_{n}} t \cdot λ \cdot {e}^{- λ \cdot t} d t}{{\int }_{{S}_{n - 1}}^{{S}_{n - 1} + {t}_{n}} λ \cdot {e}^{- λ \cdot t} d t} & ( 9 ) \\ {T}_{int\_mean} = \frac{( {S}_{n - 1} + \frac{1}{λ} ) \cdot ( 1 - {e}^{- λ \cdot {t}_{n}} ) - {t}_{n} \cdot {e}^{- λ \cdot {t}_{n}}}{1 - {e}^{- λ \cdot {t}_{n}}} & ( 10 )\end{matrix}$$

The probability that a UL frame is present at MSS in the n^{th} sleep interval, where

$${S}_{n - 1} < {t}_{t} < {S}_{n - 1} + {t}_{n} \\ P ( {S}_{n - 1} < {t}_{t} < {S}_{n - 1} + {t}_{n} ) = {\int }_{{S}_{n - 1}}^{{S}_{n - 1} + {t}_{n}} {λ}_{u} \cdot {e}^{- {λ}_{u} \cdot t} d t \\ = {e}^{- {S}_{n - 1} \cdot {λ}_{u}} \cdot ( 1 - {e}^{- {t}_{n} \cdot {λ}_{u}} ) \qquad ( 11 )$$

The probability that no DL frame arrives at BS for MSS during n^{th} sleep interval is given as

$${P}_{2} = P ( {S}_{n - 1} < {t}_{t} < {S}_{n - 1} + {t}_{n} ) * \\ P ( \overline{{d}_{{th}^{′}}} , \overline{{d}_{1}} , \overline{{d}_{2}} … \overline{{d}_{n - {1}^{′}}} \overline{ {d}_{Sn - 1 y} - L < t < {t}_{t}} ) \\ = {e}^{- {S}_{n - 1} \cdot {λ}_{u}} \cdot ( 1 - {e}^{- {t}_{n} \cdot {λ}_{u}} ) \cdot ( {e}^{- {S}_{n - 1} \cdot {λ}_{d}} ) \cdot ( {e}^{- {λ}_{d} \cdot ( {t}_{t} - {S}_{n - 1} - L )} ) \qquad ( 12 )$$

Average energy consumption during this period

$${E}_{2} = {T}_{th - mean} \cdot {E}_{th} + ( {\sum }_{k = 1}^{n - 1} {t}_{k} {E}_{s} + ( n - 2 ) \cdot L \cdot {E}_{L} ) + ( {T}_{int - mean} - {\sum }_{n = 1}^{n} {t}_{k} - ( n - 1 ) L ) \cdot {E}_{s} \qquad ( 13 )$$

Average delay contributed due to sleep mode

D₂=0 (14)

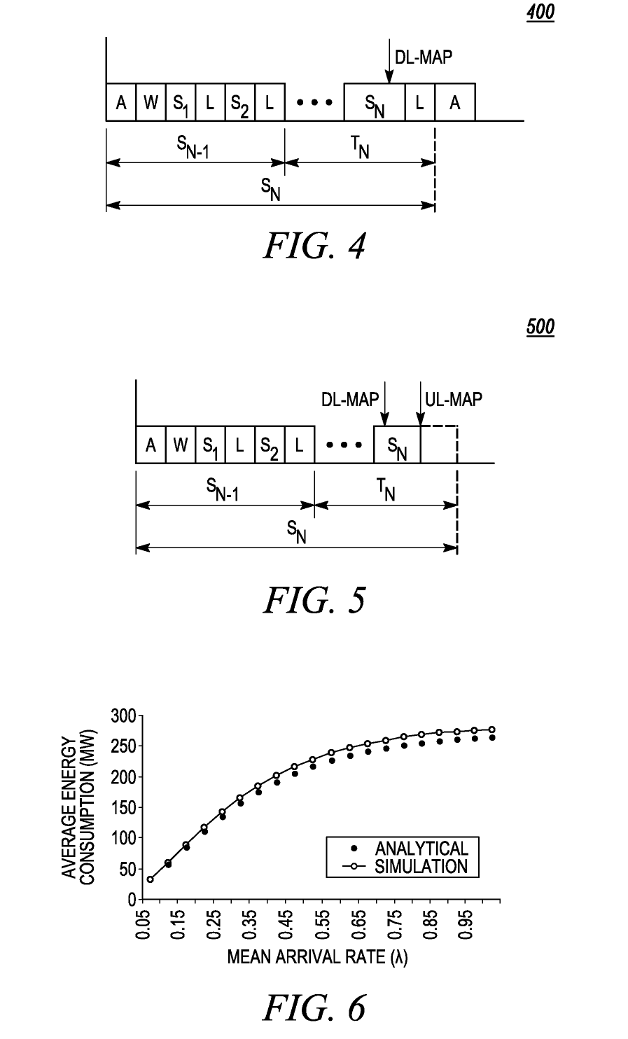

FIG. 4 illustrates a DL MAP arriving at the BS for the MSS with no UL MAP present at the MSS. In Case III, when the DL MAP arrives (↓) at the BS for the MSS during n^{th} sleep interval while there is no UL frame present at MSS such that:

Tₜₕ_{_{—}}ₘₑₐₙ=4.717*(λ³)−12.49*(λ²)+21.13*(λ)+1.152 (15)

The average time at which DL frame arrives at MSS is given by determining the Tᵢₙₜ_{_{—}}ₘₑₐₙ and is given as:

$$\begin{matrix}{T}_{int\_mean} = \frac{{\int }_{{S}_{n - 1}}^{{S}_{n - 1} + {t}_{n}} t \cdot λ \cdot {e}^{- λ \cdot t} d t}{{\int }_{{S}_{n - 1}}^{{S}_{n - 1} + {t}_{n}} λ \cdot {e}^{- λ \cdot t} d t} & ( 16 ) \\ {T}_{int\_mean} = \frac{( {S}_{n - 1} + \frac{1}{λ} ) \cdot ( 1 - {e}^{- λ \cdot {t}_{n}} ) - {t}_{n} \cdot {e}^{- λ \cdot {t}_{n}}}{1 - {e}^{- λ \cdot {t}_{n}}} & ( 17 )\end{matrix}$$

The probability that there is a DL MAP for the MSS at the BS in the sleep period where Sₙ₋₁ <tₜ<Sₙ₋₁+tₙ

$$P ( {S}_{n - 1} < {t}_{t} < {S}_{n - 1} + {t}_{n} ) = {\int }_{{S}_{n - 1}}^{{S}_{n - 1} + {t}_{n}} {λ}_{d} \cdot {e}^{- {λ}_{d} \cdot t} d t \\ = {e}^{- {S}_{n - 1} \cdot {λ}_{d}} \cdot ( 1 - {e}^{- {t}_{n} \cdot {λ}_{d}} ) \qquad ( 18 )$$

The probability that there is no UL MAP present at MSS during the sleep period

P₃=P( d̅ₜ̅ₕ̅, d̅₁̅, d̅₂̅, . . . d̅_̅{̅n̅ 1̅}̅, d̅_̅{̅S̅n̅-̅1̅}̅−̅L̅<̅t̅<̅t̅ₜ̅)=e^{-S}^{_{n−1}}^{·λ}^{_{d}}·(1−e^{-t}^{ₙ}^{·λ}^{_{d}})·(e^{-S}^{_{n−1}}^{·λ}^{ᵤ})·(e^{—λ}^{ᵤ}^{·(t}^{ₜ} ^{-S}^{_{n−1}} ^{L})) (19)

The average energy consumption at MSS during sleep period

$${E}_{3} = {T}_{th - mean} \cdot {E}_{th} + ( {\sum }_{k = 1}^{n} {t}_{k} {E}_{s} + ( n - 1 ) \cdot L \cdot {E}_{L} ) {E}_{s} \qquad ( 20 )$$

Average delay contributed due to the sleep mode

D₃=P₃*(Sₙ/2) (21)

FIG. 5 illustrates a timing diagram showing the MSS in a sleep mode that is interrupted by arrival of a UL map (↓) with at least one DL MAP (↓) present at the BS for the MSS during the n^{th} sleep interval. In case IV, when the UL frame is present at the MSS for transmission with at least one DL frame arrival at the BS for the MSS in the n^{th} sleep interval:

T_{th mean}=4.717*(λ³)−12.49 *(λ²)+21.13 *(λ)+1.152 (22)

The average time at which UL frame will be present at MSS for transmission is given by determining the Tᵢₙₜ_{_{—}}ₘₑₐₙ and is given as:

$$\begin{matrix}{T}_{int\_mean} = \frac{{\int }_{{S}_{n - 1}}^{{S}_{n - 1} + {t}_{n}} t \cdot λ \cdot {e}^{- λ \cdot t} d t}{{\int }_{{S}_{n - 1}}^{{S}_{n - 1} + {t}_{n}} λ \cdot {e}^{- λ \cdot t} d t} & ( 23 ) \\ {T}_{int\_mean} = \frac{( {S}_{n - 1} + \frac{1}{λ} ) \cdot ( 1 - {e}^{- λ \cdot {t}_{n}} ) - {t}_{n} \cdot {e}^{- λ \cdot {t}_{n}}}{1 - {e}^{- λ \cdot {t}_{n}}} & ( 24 )\end{matrix}$$

The probability that UL frame is present at MSS during the n^{th} sleep interval, where Sₙ₋₁<tₜ<Sₙ₋₁+tₙ

$$P ( {S}_{n - 1} < {t}_{t} < {S}_{n - 1} + {t}_{n} ) = {\int }_{{S}_{n - 1}}^{{S}_{n - 1} + {t}_{n}} {λ}_{u} \cdot {e}^{- {λ}_{u} \cdot t} d t \\ = {e}^{- {S}_{n - 1} \cdot {λ}_{u}} \cdot ( 1 - {e}^{- {t}_{n} \cdot {λ}_{u}} ) \qquad ( 25 )$$

The probability that DL frame arrives at BS for the MSS during the n^{th} sleep interval is given as

P₄=P(Sₙ₋₁<tₜ<Sₙ₋₁+t_{n)*}P( d̅ₜ̅ₕ̅, d̅₁̅, d̅₂̅ . . . d̅ₙ̅₋̅₁̅,d_{Sn-1}−L<t<tₜ)=e^{-S}^{_{n−1}}^{·λ}^{ᵤ}·(1−e^{-t}^{ₙ}^{·λ}^{ᵤ})·(e^{-S}^{_{n−1}}^{·λ}^{_{d}})·(1−e^{-λ}^{_{d}}^{·t}^{ₜ}^{-S}^{_{n−1}}⁻¹⁾) (26)

Average energy consumption at MSS during waiting time threshold duration

$${E}_{4} = {T}_{th - mean} \cdot {E}_{th} + ( {\sum }_{k = 1}^{n - 1} {t}_{k} {E}_{s} + ( n - 2 ) \cdot L \cdot {E}_{L} ) + ( {T}_{int - mean} - {\sum }_{n = 1}^{n} {t}_{k} - ( n - 1 ) L ) \cdot {E}_{s} \qquad ( 27 )$$

Average delay time contributed due to sleep mode is given as

D₄=P₄*(Tᵢₙₜ_{_{—}}ₘₑₐₙ−Sₙ₋₁−(tₙ/2)) (28)

The total average energy consumed is given by

$$= {\sum }_{i = 1}^{∞} {P}_{1} \cdot {E}_{1} + {P}_{2} \cdot {E}_{2} + {P}_{3} \cdot {E}_{3} + {P}_{4} \cdot {E}_{4} \qquad ( 29 )$$

The total average delay is given by

$$= {\sum }_{i = 1}^{∞} {P}_{3} \cdot {D}_{3} + {P}_{4} \cdot {D}_{4} \qquad ( 30 )$$

With regard to the analytical and simulation results and the parameters used to evaluate the algorithm, a simulation was achieved using a Java discrete event simulation. The simulation model was also validated with published simulation results performed on an NS2 platform. A total simulation time was 400 sec, and the results were obtained by taking an average value of 100 samples of a traffic sequence for each arrival rate λ. The following parameters were chosen for the simulation: mean arrival rate λ=λ_{d}+λᵤ varying from 0.05 to 1.0 where one frame duration=5 ms, α=0.01, β=4.865, listening duration L=5 ms, initial sleep duration tₘᵢₙ=10 ms, and maximum sleep duration tₘₐₓ=160 ms has been taken. Energy consumption values for waiting time threshold duration and sleep duration were taken as Eₜₕ=280 mw and Eₛ=10 mw, respectively.

Furthermore, fixed waiting time threshold for an existing algorithm was taken as Tₜₕ=25 ms, and the algorithm uses a minimum waiting time threshold Tₜₕ_{_{—}}ₘᵢₙ=5 ms and maximum waiting time threshold Tₜₕ_{_{—}}ₘₐₓ=50 ms. If an analysis were performed using two traffic cases such that Case I is the ratio of DL versus UL traffic is taken as R=4 where R=λ_{d}/λᵤ. Case II is the ratio of DL versus UL traffic taken as R=¼ where R=λ_{d}/λᵤ. In the discussions below, we compare the results of our proposed algorithm with the result of constant threshold scheme.

FIG. 6 is a graph illustrating a comparison of average energy consumption (mW) by the MSS versus the mean arrival rate (λ) at R=4 for analytical and simulation results validates the simulation and analytical results for the algorithm as described herein. These results illustrate energy consumption by the MSS at different mean arrival rates (λ). Energy consumption values for analytical results are calculated by Eq. (29) such that analytical and simulation results are similar to each other.

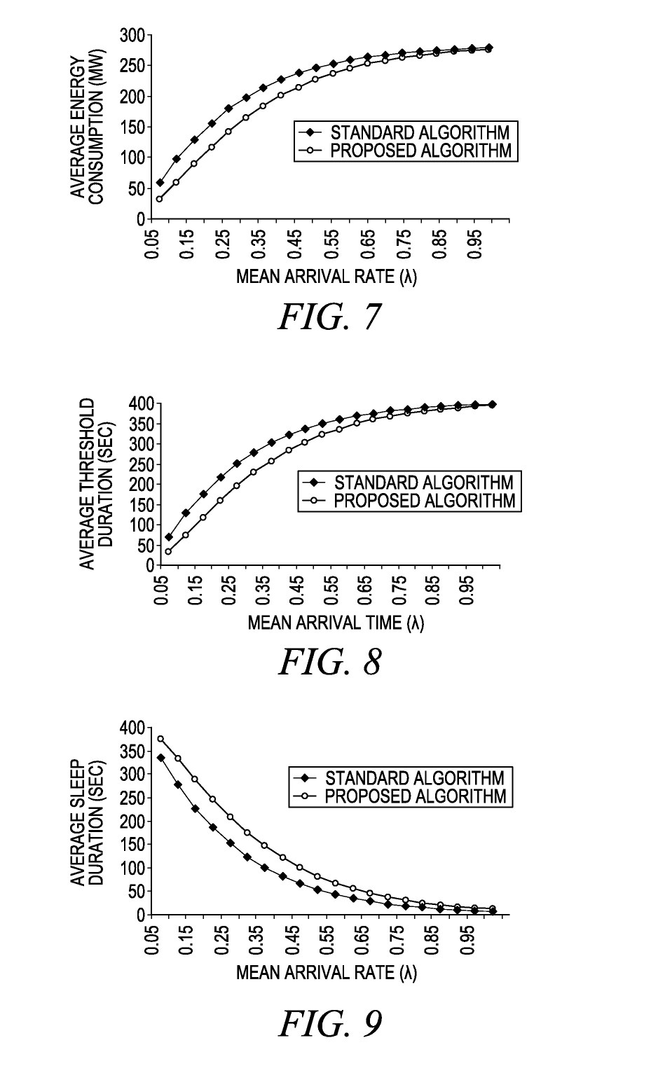

FIG. 7 illustrates a graph showing the average energy consumption by the MSS for standard algorithm and algorithm of the present invention with respect to mean arrival rate λ. In Case I, R (λ_{d}:λᵤ)=4:1 where the downlink traffic is four times more than uplink traffic. It has been observed that the algorithm according to an embodiment of the invention can significantly reduce energy consumption. Maximum reduction achieved is 47% at λ=0.05 and 12% on an average over λ=0.05 to 1. Significant reduction is observed because the algorithm described herein does a novel and unique estimation of the waiting time threshold, while the algorithm used in connection with the standard calculates a constant value.

FIG. 8 is a graph illustrating a comparison of average threshold duration versus mean arrival rate (λ) at R=4 for the standard algorithm and the algorithm proposed by an embodiment of the present invention. In view of the different methods for calculating waiting time characteristics, the total waiting time threshold duration is reduced and total sleep duration is increased.

FIG. 9 is a graph illustrating a comparison between average sleep duration versus mean arrival rate (λ) at R=4 for the standard algorithm and the algorithm proposed by an embodiment of the present invention. The MSS is active during the waiting time threshold duration such that energy consumption is approximately twenty-eight times greater than energy consumption during sleep mode (Eₜₕ: Eₛ=280:10). As a result, significant reduction in energy consumption by the MSS is achieved where the reduction is more prominent at a low arrival rate because the algorithm of the present invention predicts a smaller value of waiting time threshold. This results into less waiting time and more sleep while algorithm used in the standard maintains a constant waiting time threshold.

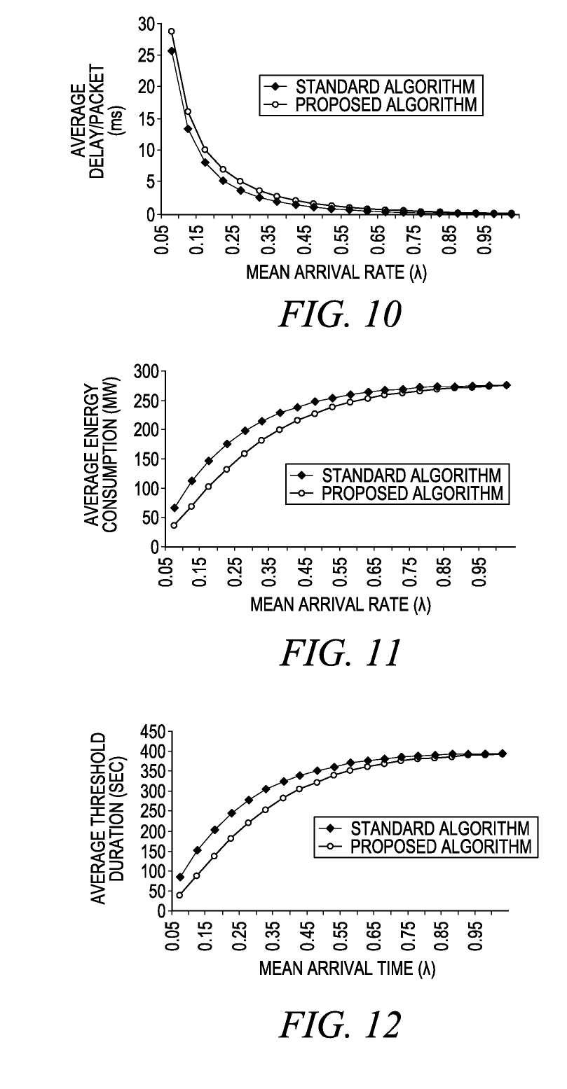

FIG. 10 is a graph illustrating a comparison between average delay in transmission of DL and UL frames due to the MSS in sleep mode versus the mean arrival rate (λ) at R=4 for the standard algorithm and the algorithm proposed by an embodiment of the present invention. The graph shows how average delay contributed due to sleep mode versus mean traffic rate (λ). This analysis illustrates that due to the algorithm used in the present invention, there is a little increase of 11% delay with 47% decrease in energy consumption at low arrival traffic rate. This occurs since the algorithm used in the present invention increases probability of the MSS going to sleep mode by predicting a smaller threshold value. Thus, any packet that arrives during sleep mode experiences little delay, which is acceptable for non-real time (Class A) traffic. FIG. 7 and FIG. 10 further illustrate that at a high arrival rate, most of the time the MSS remains in active mode and hence follows the same trend in energy consumption and delay for both algorithms used in the invention and that used in the standard.

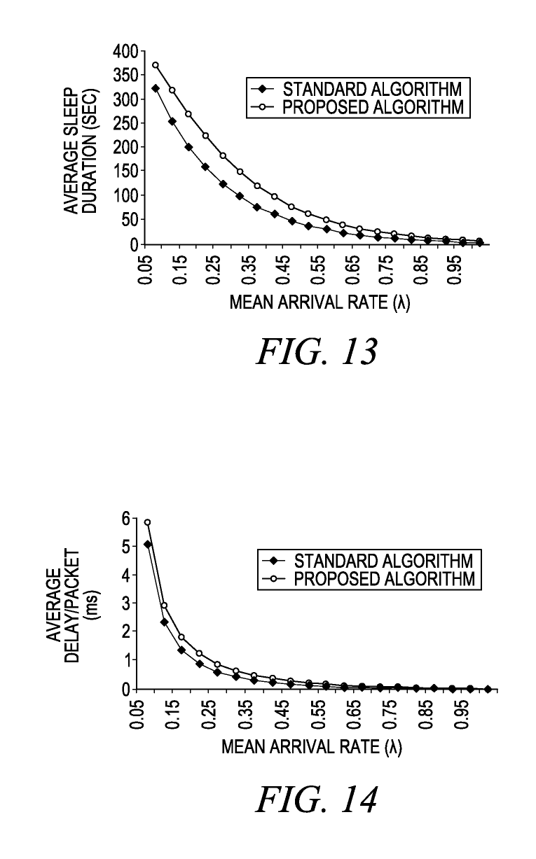

FIG. 11 is a graph illustrating a comparison between average energy consumption versus mean arrival rate (λ) at R=4 for the standard algorithm and the algorithm proposed by an embodiment of the present invention. For Case II, R(λ_{d}:λᵤ)=1:4. FIG. 12 is a graph illustrating a comparison between average threshold duration versus mean arrival rate (λ) at R=4 for the standard algorithm and the algorithm proposed by an embodiment of the present invention. In the illustration, traffic is four times more than downlink traffic. FIG. 13 is a graph illustrating a comparison between average sleep duration versus mean arrival rate (λ) at R=4 for the standard algorithm and the algorithm proposed by an embodiment of the present invention. Hence, FIGS. 11-13 show average power consumption, total waiting threshold, and total sleep duration, respectively. Like those of Case I, similar trends are observed with same maximum reduction in energy consumption equals to approximately 47% at λ=0.05 and on an average 12% over λ=0.05 to 1.

FIG. 14 is a graph illustrating a comparison between the average delay in transmission of the DL and UL frames due to the MSS in sleep mode versus mean arrival rate (λ) at R=4 for the standard algorithm and the algorithm proposed by an embodiment of the present invention. Thus, this illustration presents average delay contributed due to sleep mode versus mean traffic rate (λ). This study shows that the increase in delay due to proposed algorithm is 11% at arrival rate λ=0.05, which is similar as in Case I. Consequently, for both DL and UL traffic frames, the algorithm of the present invention provides a significant power savings with consistent performance.

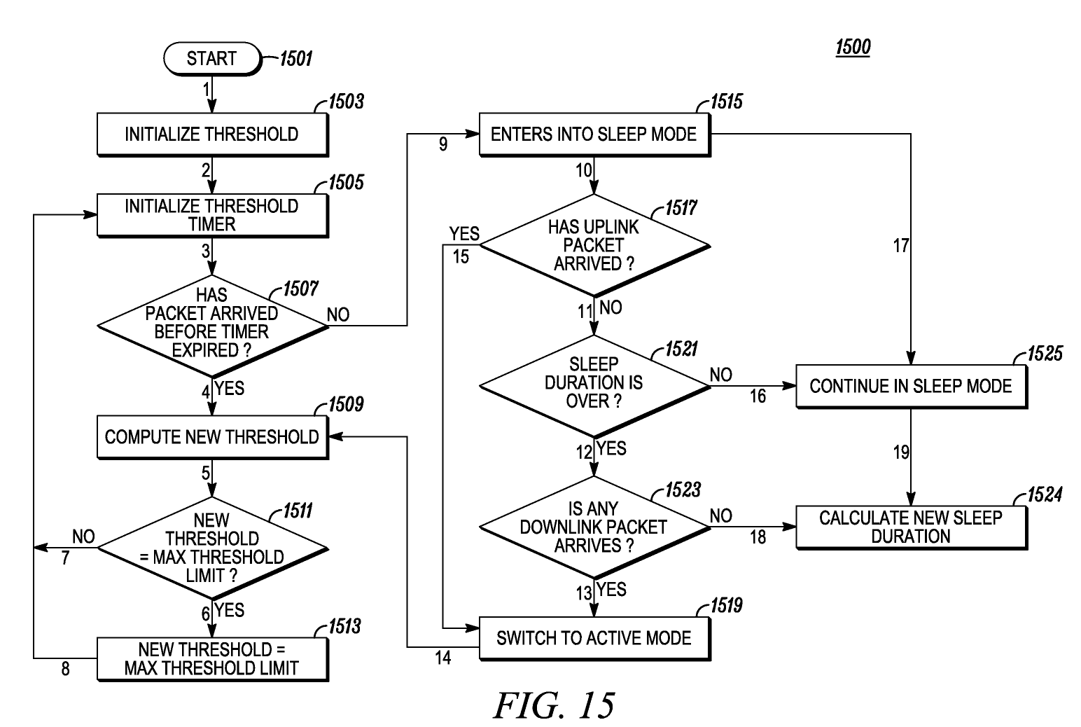

FIG. 15 is a flowchart diagram illustrating the method 1500 using the algorithm of an embodiment of the present invention used in an electronic device. The method starts 1501 where a MSS is switched on and starts operation. The MSS initializes a waiting time threshold duration with a default value 1503 and then initializes waiting time threshold timer and waits for waiting time threshold time to expire.

Subsequently, a timer operates to determine if the MSS arrives before timer expiration by checking the channel for packet arrival (DL/UL) 1507. In the case of packet arrival, i.e., the MSS has received a packet during waiting time threshold period, a new waiting time threshold is computed based on the current traffic condition 1507. The MSS then checks whether the new threshold duration is more than the maximum threshold 1511. If not, the MSS reinitializes the waiting time threshold timer with new computed value of waiting time threshold 1505. If the new threshold duration is greater than the maximum threshold duration, then the new computed waiting time is substantially equal to the maximum limit for the waiting time duration 1513, the MSS reinitializes the waiting time threshold time with the maximum limit for the waiting time threshold duration 1505. In cases of absence of packet arrival during the waiting time threshold duration 1507, the MSS enters into a sleep mode 1515. The MSS continues to be in sleep mode 1525 and the MSS calculates new sleep duration 1527. While in sleep mode, the MSS determines if there has been an uplink packet arrival 1517. If any uplink packet has arrived, then MSS immediately switches to active mode and computes a new waiting time threshold based on current conditions 1509.

In case of absence of packet arrival during sleep duration, MSS continues to be in sleep mode until the end of current sleep duration 1521. If the sleep duration is over, the MSS checks the channel for downlink packet arrival 1523. In case of arrival of downlink packet, the MSS switches to active mode 1519 and computes a new waiting time threshold based on current conditions 1509.

If the sleep duration is not over 1521, then MSS continues to be in sleep mode 1525 and the MSS calculates new sleep duration 1527. Similarly, in the case of absence of downlink packet during listening period, then MSS calculates new sleep duration using binary exponential algorithm 1527.

Hence, the method as set forth in the present invention operates to modify the existing constant waiting time threshold scheme as set forth in the standard by making it adaptive to the varying downlink and uplink traffic pattern. It should be recognized that the traffic arrival pattern is an important factor for the waiting time threshold control. An evaluation of the sleep mode operation of the IEEE 802.16(e) standard uses an analytical model that takes into account the various cases of arrival of uplink and downlink frames at the MSS, which breaks the sleep mode. Analysis of the average delay and the average energy consumption under the sleep mode operation show that potential saving in energy consumption in sleep mode is achieved if waiting time threshold duration is intelligently predicted according to the traffic arrival pattern. Moreover, the method using the algorithm of the present invention shows consistent good performance for every kind of traffic condition. It is clear that the analysis and the simulation match with each other well and may also operate for future predictions of packet loss at BS and optimum buffer sizes.

The present invention utilizes a novel method using an algorithm for estimating optimum waiting time threshold with respect to traffic condition. The method of the invention minimizes waiting time threshold in the event of a large inter arrival time so that MSS goes to sleep mode quickly. This results in increased sleep duration. In cases of a short inter arrival time, the method will increase waiting time threshold so that the MSS waits a greater time before transitioning to a sleep mode. This reduces frequent switching between sleep-active mode which leads to a significant savings in energy consumption in both uplink and downlink traffic conditions. Only non real time traffic (Class A) has been considered since in case of real time traffic (Class B), traffic conditions are known in advance. In cases of non real time traffic (Class A), these packet arrival times are unpredictable. Therefore, estimating waiting time threshold according to traffic arrival for non real time traffic has a large impact on power savings.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for dynamically varying waiting time threshold in a wireless communications system comprising the steps of:
operating a mobile subscriber station (MSS) in the communications system;
calculating a value for an average arrival rate based on a downlink and uplink traffic arrival pattern; and
minimizing a waiting time threshold in case of larger inter arrival time so that the MSS transitions into a sleep made in a substantially rapid manner for proving a longer sleep duration.

2. A method for dynamically varying waiting time threshold in a wireless communications system as in claim 1, further comprising the steps of:
increasing the wait time threshold when a substantially short inter arrival time between either uplink packets or downlink packets occur.

3. A method for dynamically varying waiting time threshold in a wireless communications system as in claim 1, wherein the method can be used with the IEEE 802.16 standard.

4. A method for dynamically varying waiting time threshold in a wireless communications system as in claim 1, further comprising the step of:
calculating the first new waiting time threshold (Tₜₕ) duration based on the equation:
Tₜₕ=Tₜₕ+β*(λₙ−λₙ₋₁) such that:
λₙ=(1−α)*λ_{new}+α*λₙ₋₁, 0<α<1
where α is proportionality constant, β is a shaping factor greater than zero, λ_{new} is new arrival rate, λₙ is weighted arrival rate after n^{th} packet arrival, λₙ₋₁ is weighted arrival rate after (n−1)^{th} packet arrival.

5. A method for enhancing power efficiency during sleep mode operation in an electronic device, comprising the steps of:
operating a mobile device using a default wait time threshold duration;
initializing a waiting time threshold timer to the default wait time threshold duration;
computing a first new wait time threshold duration based on current traffic conditions if a packet is received at the mobile device during the default wait time threshold;
entering a sleep mode if no packet is received during the default wait time duration;
immediately switching to an active mode if in sleep mode and an uplink packet arrives and calculating a second new wait time threshold duration based on current traffic conditions; and
concluding sleep mode and switching to an active mode if a downlink packet arrives and calculating a third new waiting time threshold according to current traffic conditions.

6. A method for enhancing power efficiency during sleep mode operation as in claim 5, further comprising the step of:
calculating the first new waiting time threshold (Tₜₕ) duration based on the equation:
Tₜₕ=Tₜₕ+β*(λₙ−λₙ₋₁) such that:
λₙ=(1−α)*λ_{new}+α*λₙ₋₁, 0<α<1
where α is proportionality constant, β is a shaping factor greater than zero, λ_{new} is new arrival rate, λₙ is weighted arrival rate after n^{th} packet arrival, λₙ₋₁ is weighted arrival rate after (n−1)^{th} packet arrival.

7. A method for dynamically varying a waiting time threshold in a communications system utilizing wireless mobile devices for conserving battery life comprising the steps of:
initializing a threshold timer in the wireless mobile device for initiating an default wait time threshold;
determining if an uplink packet or downlink packet has arrived before expiration of the threshold timer;
computing a first new wait time threshold if an uplink packet or downlink packet has arrived;
entering a sleep mode having a first sleep mode period if no uplink packet or downlink packet has arrived;
transitioning to an active mode upon arrival of an uplink packet and computing a second new wait time threshold;
transitioning to an active mode upon arrival of a downlink packet and expiration of a first sleep mode period; and
calculating a second sleep mode period if no uplink packet or downlink packet are received.

8. A method for dynamically varying waiting time threshold in a wireless communications system as in claim 7, further comprising the step of:
determining if the first new wait time threshold exceeds a maximum threshold limit after the first new wait time threshold is computed; and
setting the first new wait time threshold to the maximum threshold limit if the maximum threshold limit is exceeded.

9. A method for dynamically varying waiting time threshold in a wireless communications system as in claim 7, wherein the method may be used with the IEEE 802.16 standard.

10. A method for dynamically varying waiting time threshold in a wireless communications system as in claim 7, further comprising the step of:
calculating the first new waiting time threshold (Tₜₕ) duration based on the equation:
Tₜₕ=Tₜₕ+β*(λₙ−λₙ₋₁) such that:
λₙ=(1−α)*λ_{new}+α*λₙ₋₁, 0<α<1
where α is proportionality constant, β is a shaping factor greater than zero, λ_{new} is new arrival rate, λₙ is weighted arrival rate after n^{th} packet arrival, λₙ₋₁ is weighted arrival rate after (n−1)^{th} packet arrival.
